(19) United States
(12) Patent Application Publication
(10) Pub. No.: US 2025/0271795 A1
(43) Pub. Date: Aug. 28, 2025

(54) FIXING MEMBER, FIXING DEVICE, AND IMAGE FORMING APPARATUS

(71) Applicant: FUJIFILM Business Innovation Corp., Tokyo (JP)

(72) Inventors: Yasuhiko KINUTA, Kanagawa (JP); Shogo HAYASHI, Kanagawa (JP); Ryosuke KUBOTA, Kanagawa (JP); Iori NISHIMURA, Kanagawa (JP)

(73) Assignee: FUJIFILM Business Innovation Corp., Tokyo (JP)

(21) Appl. No.: 19/004,473

(22) Filed: Dec. 30, 2024

(30) Foreign Application Priority Data
Feb. 22, 2024 (JP) 2024-025722

(51) Int. Cl. G03G 15/20

(52) U.S. Cl. CPC G03G 15/2057; G03G 15/206; G03G 15/2064; G03G 2215/2048

(57) ABSTRACT

A fixing member includes a surface layer having a sliding angle of 25 degrees or less at 150° C. with respect to a Fischer-Tropsch wax having a melting point of 90° C. and a penetration of 3 ( 1/10 mm).

### CROSS-REFERENCE TO RELATED APPLICATIONS

This application is based on and claims priority under 35 USC 119 from Japanese Patent Application No. 2024-025722 filed Feb. 22, 2024.

### BACKGROUND

### (i) Technical Field

The present invention relates to a fixing member, a fixing device, and an image forming apparatus.

### (ii) Related Art

In an image forming apparatus (such as a copy machine, a facsimile machine, or a printer) using an electrophotographic method, an image is formed by fixing an unfixed toner image formed on a recording material by a fixing device.

For example, JP7222294B discloses “a fixing member used for fixing a toner image containing at least a wax, the fixing member including at least an elastic layer and a release layer on a substrate, in which the release layer is a layer obtained by curing a coating liquid containing at least trimethylolpropane trimethacrylate and perfluoropolyether polyurethane (meth)acrylate, and when a static contact angle and a sliding angle with respect to a surface of the release layer are measured using a 100° C. melt solution of docosyl docosanoate or solid paraffin as the wax, the static contact angle is 70° or more and the sliding angle is less than 45°”.

### SUMMARY

Aspects of non-limiting embodiments of the present disclosure relate to a fixing member in which gloss unevenness is suppressed as compared with a fixing member having a surface layer with a sliding angle of more than 25 degrees at 150° C. with respect to a Fischer-Tropsch wax having a melting point of 90° C. and a penetration of 3 ( 1/10 mm).

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for addressing the problems include the following aspects.

According to an aspect of the present disclosure, there is provided a fixing member including: a surface layer having a sliding angle of 25 degrees or less at 150° C. with respect to a Fischer-Tropsch wax having a melting point of 90° C. and a penetration of 3 ( 1/10 mm).

### BRIEF DESCRIPTION OF THE DRAWINGS

Exemplary embodiment(s) of the present invention will be described in detail based on the following figures, wherein:

FIG. 1 is a schematic configuration view showing an example of a fixing device according to a first exemplary embodiment;

FIG. 2 is a schematic configuration view showing an example of a fixing device according to a second exemplary embodiment;

FIG. 3 is a schematic configuration view showing an example of a fixing device according to a third exemplary embodiment; and

FIG. 4 is a schematic configuration view showing an example of an image forming apparatus according to the present exemplary embodiment.

### DETAILED DESCRIPTION

Hereinafter, the present exemplary embodiment as an example of the present invention will be described. The following descriptions and examples merely illustrate the exemplary embodiments, and do not limit the scope of the exemplary embodiments.

Regarding the ranges of numerical values described in stages in the present exemplary embodiment, the upper limit value or lower limit value described in one range of numerical values may be replaced with the upper limit value or lower limit value of another range of numerical values described in stages. In addition, regarding the ranges of numerical values described in the present exemplary embodiment, the upper limit value or lower limit value of a range of numerical values may be replaced with values described in examples.

In the present exemplary embodiment, the term “step” includes not only an independent step but also a step that cannot be clearly distinguished from other steps but can achieve the expected object thereof.

In the present exemplary embodiment, in a case where an exemplary embodiment is described with reference to drawings, the configuration of the exemplary embodiment is not limited to the configuration shown in the drawings. In addition, the sizes of members in each drawing are conceptual and a relative relationship between the sizes of the members is not limited thereto.

In the present exemplary embodiment, each component may include two or more kinds of corresponding substances. In a case where the amount of each component in a composition is mentioned in the present exemplary embodiment, and there are two or more kinds of substances corresponding to each component in the composition, unless otherwise specified, the amount of each component means the total amount of two or more kinds of the substances present in the composition.

### Fixing Member

A fixing member according to the present exemplary embodiment has a surface layer with a sliding angle of 25 degrees or less at 150° C. with respect to a Fischer-Tropsch wax having a melting point of 90° C. and a penetration of 3 ( 1/10 mm).

Since the fixing member according to the present exemplary embodiment has the above-described configuration, gloss unevenness is suppressed. The reason for this effect is presumed as follows.

Here, in recent years, in an electrophotographic image forming apparatus, there is an increasing demand for forming an image on a medium having an ultrahigh smooth surface, such as a transparent film or a high-gloss paper, due to the diversification of recording media.

In the image formation on the smooth surface medium, the image quality requirements such as glossiness and the like are higher than in the related art.

In the related art, in a fixing device that has a large influence on glossiness, for example, a fluororesin such as perfluoroalkoxyalkane (PFA) has been used for a surface layer of a fixing member from the viewpoint of high releasability, heat resistance, flexibility, workability, and the like.

However, in the surface layer formed of a fluororesin, the releasability with respect to a toner is not sufficient. Therefore, a toner including a mold release agent is applied, and the mold release agent is melted during the fixing of the toner to elute the mold release agent on the surface of the toner. As a result, the surface of the fixing member and the toner surface are separated from each other by the mold release agent, and thus the releasability with respect to the toner is ensured.

However, in a case where the mold release agent is transferred and remains on the surface of the fixing member, gloss unevenness called wax offset occurs.

In particular, in a high image quality printing market for a transparent film or high-gloss paper, where high image quality is required, the visibility of gloss unevenness called wax offset is increased, and thus improvement is desired.

Therefore, in the fixing member according to the present exemplary embodiment, the sliding angle of the surface layer with respect to the Fischer-Tropsch wax at 150° C. is set to 25 degrees or less.

As a result, the releasability of the surface layer of the fixing member with respect to the mold release agent is increased, and the mold release agent is less likely to remain on the surface of the fixing member. Therefore, gloss unevenness called wax offset is less likely to occur, and gloss unevenness is less likely to be visually recognized even in high image quality printing on a transparent film or high-gloss paper.

From the above, it is presumed that the fixing member according to the present exemplary embodiment suppresses gloss unevenness.

Hereinafter, a configuration of the fixing member according to the present exemplary embodiment will be described.

The fixing member according to the present exemplary embodiment has, for example, a substrate, an elastic layer provided on the substrate, and a surface layer provided on the elastic layer.

In addition, the surface layer has a sliding angle of 25 degrees or less at 150° C. with respect to a Fischer-Tropsch wax having a melting point of 90° C. and a penetration of 3 ( 1/10 mm).

The fixing member according to the present exemplary embodiment is not limited to the above-described layer configuration, and may have a layer configuration in which, for example, a metal layer and a protective layer thereof, and an adhesive layer are interposed between the substrate and the elastic layer, as necessary.

In addition, a layer configuration in which an adhesive layer is interposed between the elastic layer and the surface layer may be adopted.

Hereinafter, components of the fixing member according to the present exemplary embodiment will be described in detail. Further, the reference numerals will not be provided.

### Shape of Fixing Member

The fixing member according to the present exemplary embodiment may have a roll shape or a belt shape.

### Substrate

In a case where the fixing member is in the form of a roll, examples of the substrate include a cylindrical substance configured with a metal (such as aluminum, SUS, iron, or copper), an alloy, ceramics, a fiber reinforced metal (FRM), or the like.

In a case where the fixing member is in the form of a roll, as for the outer diameter and a wall thickness of the substrate, for example, the outer diameter may be 10 mm or more and 50 mm or less. For example, in a case where the fixing member is made of aluminum, the thickness is 0.5 mm or more and 4 mm or less, and in a case where the fixing member is made of stainless steel (SUS) or iron, the thickness is 0.1 mm or more and 2 mm or less.

On the other hand, in a case where the fixing member has the belt shape, examples of the base material include a metal belt (for example, a metal belt of nickel, aluminum, stainless steel, or the like) or a resin belt (for example, a resin belt of polyimide, polyamideimide, polyphenylene sulfide, polyether etherketone, polybenzimidazole, or the like).

The volume resistivity may be controlled by adding and dispersing a conductive powder or the like to the resin belt. Specifically, examples of the resin belt include a polyimide belt in which carbon black is added and dispersed such that the volume resistivity is controlled. In addition, examples of the resin belt include a belt formed by combining both ends of a long polyimide sheet on a puzzle and performing thermocompression by using a thermocompression member to obtain a belt-shaped product.

In a case where the fixing member is in the form of a belt, the thickness of the substrate is, for example, preferably 20 μm or more and 200 μm or less, more preferably 30 μm or more and 150 μm or less, and still more preferably 40 μm or more and 130 μm or less.

Regarding the substrate, a metal layer may be provided on the substrate as necessary. In a case where the metal layer is provided, the metal layer may be formed in a single layer or may be formed in multiple layers. The metal layer formed in a single layer may be a metal layer that generates heat by itself due to an electromagnetic induction action. In addition, the metal layer formed in multiple layers may be formed in a three-layer structure of, for example, an underlayer metal layer, an electromagnetic induction metal layer, and a metal protective layer.

In addition, an adhesive may be applied to the surface of the substrate (including the substrate provided with a metal layer). That is, the adhesive is used as necessary, and the substrate (or the metal layer on the substrate) and the elastic layer may be laminated with the adhesive interposed therebetween. The adhesive is not particularly limited, and examples thereof include an adhesive compound (adhesive) having a hydrogen-bonded silyl group (—SiH) to which a hydrogen atom is bonded, and the like.

### Elastic Layer

The elastic layer may be configured to include a heat-resistant elastic material which restores the original shape even in a case of being deformed by applying an external force of, for example, 100 Pa.

Examples of the heat-resistant elastic material include a fluororesin, a silicone resin, silicone rubber, fluororubber, and fluorosilicone rubber. As the heat-resistant elastic material, from the viewpoint of heat resistance, thermal conductivity, insulating properties, and the like, for example, silicone rubber and fluororubber are preferable, and silicone rubber is more preferable.

Examples of the silicone rubber include RTV silicone rubber, HTV silicone rubber, liquid silicone rubber, and the like. Specific examples thereof include polydimethyl silicone rubber (MQ), methyl vinyl silicone rubber (VMQ), methyl phenyl silicone rubber (PMQ), and fluorosilicone rubber (FVMQ), and the like.

Examples of a commercially available product of the silicone rubber include liquid silicone rubber SE6744 manufactured by Dow Corning Toray Co., Ltd, and the like.

As the silicone rubber, for example, silicone rubber that is crosslinked generally by an addition reaction is preferable. Various types of functional groups are known for silicone rubber. As the silicone rubber, for example, dimethyl silicone rubber having a methyl group, methyl phenyl silicone rubber having a methyl group and a phenyl group, vinyl silicone rubber having a vinyl group (vinyl group-containing silicone rubber), and the like are preferable. For example, vinyl silicone rubber having a vinyl group is more preferable, and silicone rubber having an organopolysiloxane structure having a vinyl group and a hydrogen organopolysiloxane structure having a hydrogen atom (SiH) bonded to a silicon atom is still more preferable.

Examples of the fluororubber include vinylidene fluoride-based rubber, ethylene tetrafluoride/propylene-based rubber, ethylene tetrafluoride/perfluoromethylvinyl ether rubber, phosphazene-based rubber, and fluoropolyether.

Examples of a commercially available product of the fluororubber include VITON B-202 manufactured by DuPont Dow Elastomers, L.L.C., and the like.

For example, it is preferable that the elastic layer contains silicone rubber as a main component as the heat-resistant elastic material (that is, contains 50% by mass or more with respect to the elastic layer). The content of the silicone rubber is, for example, more preferably 90% by mass or more and still more preferably 99% by mass or more.

The elastic layer may contain an inorganic filler in addition to the heat-resistant elastic material, for the purpose of reinforcement, heat resistance, heat transfer, or the like. Examples of the inorganic filler include known inorganic fillers. For example, the inorganic filler include fumed silica, crystalline silica, iron oxide, alumina, metallic silicon, and the like are preferably included.

Examples of the material of the inorganic filler include, in addition to the above ones, known inorganic fillers such as carbides (for example, carbon black, carbon fibers, carbon nanotubes, and the like), titanium oxide, silicon carbide, talc, mica, kaolin, calcium carbonate, calcium silicate, magnesium oxide, graphite, silicon nitride, boron nitride, cerium oxide, and magnesium carbonate.

Among these, in view of thermal conductivity, for example, silicon nitride, silicon carbide, graphite, boron nitride, and carbides are preferable.

The content of the inorganic filler may be determined by the required thermal conductivity, mechanical strength, and the like, and is, for example, 1% by mass or more and 20% by mass or less with respect to the elastic layer. The content of the inorganic filler is, for example, preferably 3% by mass or more and 15% by mass or less, and more preferably 5% by mass or more and 10% by mass or less with respect to the elastic layer.

The elastic layer may contain, as an additive, for example, a softener (such as a paraffin-based softener), a processing aid (such as stearic acid), an antioxidant (such as an amine-based antioxidant), a vulcanizing agent (such as sulfur, a metal oxide, or a peroxide), a functional filler (such as alumina) and the like.

The thickness of the elastic layer is, for example, preferably 30 μm or more and 600 μm or less, and more preferably 100 μm or more and 500 μm or less.

Surface Layer Sliding Angle

The sliding angle (hereinafter, also referred to as an “FTW sliding angle”) of the surface layer with respect to a Fischer-Tropsch wax having a melting point of 90° C. and a penetration of 3 ( 1/10 mm) at 150° C. is 25 degrees or less.

In a case where the FTW sliding angle is more than 25 degrees, the releasability of the surface layer of the fixing member with respect to the mold release agent is low, and the mold release agent is likely to remain on the surface of the fixing member. Therefore, gloss unevenness called wax offset is likely to occur.

Accordingly, the FTW sliding angle is set to be within the above-described range. The FTW sliding angle is, for example, preferably 15 degrees or less and more preferably 10 degrees or less.

However, from the viewpoint of suppressing the offset of the toner, the lower limit of the FTW sliding angle is, for example, preferably 1 degree or more and more preferably 3 degrees or more.

A method of measuring the FTW sliding angle is as follows.

A test piece of the surface layer is collected from the fixing member to be measured.

On the other hand, Fischer-Tropsch wax “FNP-0090” (melting point: 90° C., penetration: 3 ( 1/10 mm): NIPPON SEIRO CO., LTD.) is prepared.

The surface temperature of the test piece of the surface layer is heated to 150° C., in a state where the wax is melted at 150° C., 1.5 μl of the melted wax is added dropwise onto the surface of the test piece of the surface layer, and the sliding angle after 3 seconds is measured by a fully automatic contact angle meter DMo-902 (manufactured by Kyowa Interface Science Co., Ltd.) equipped with a sliding method kit.

Here, the melting point of the Fischer-Tropsch wax is determined from a DSC curve obtained by differential scanning calorimetry (DSC) by “peak melting temperature” described in the method for determining the melting temperature in JIS K 7121:1987, “Testing methods for transition temperatures of plastics”.

The penetration of the Fischer-Tropsch wax is a value measured in accordance with JIS K2235: 2022. Specifically, the penetration is measured in accordance with JIS K2235: 2022, by measuring a depth at which a distal end of a standard plunger (0.1 mm) penetrates a sample under a condition of 25° C. using a weight of 50 g and the standard plunger, performing measurement for 10 samples, and taking an average value thereof as the penetration.

Examples of the method of setting the FTW sliding angle within the above-described range include a method of blending a siloxane compound, which will be described later, into the surface layer.

### Components of Surface Layer

From the viewpoint of setting the FTW sliding angle within the above-described range, the surface layer preferably contains, for example, a siloxane compound. In particular, it is preferable that the surface layer includes, for example, a siloxane compound having a structure A of Formula: [RSiO_{1.5}]ₙ (provided that in the formula, R represents an organic group, and n represents an integer of 2 or more), and at least one R among a plurality of R's in the structure A is a group including an alkyl group (hereinafter, also referred to as a “siloxane compound SQ”).

The surface layer may be a surface layer containing the siloxane compound SQ as a main component, or may be a surface layer containing a binding material as a main component and the siloxane compound SQ as an additive.

Here, the main component indicates the most abundant component among the components constituting the surface layer.

In the structure A, the organic group represented by R in the formula represents, for example, a hydroxyl group, a siloxy group, a hydrocarbon group, a hydrocarbon group in which one or a plurality of methylene groups are replaced with a carbonyl group, a hydrocarbon group in which one or a plurality of carbon atoms are replaced with a heteroatom (oxygen atom, nitrogen atom, or sulfur atom), or a group formed by a combination of these groups.

Examples of the siloxy group described as the organic group represented by R include a monoalkylsiloxy group, a dialkylsiloxy group, a trialkylsiloxy group, and the like, and for examples, a dialkylsiloxy group or a trialkylsiloxy group is preferable and a trialkylsiloxy group is more preferable.

Examples of the hydrocarbon group described as the organic group represented by R include an aliphatic hydrocarbon group and an aromatic hydrocarbon group.

Examples of the aliphatic hydrocarbon group include a linear, branched, or alicyclic saturated aliphatic hydrocarbon group, and a linear, branched, or alicyclic unsaturated aliphatic hydrocarbon group.

The aliphatic hydrocarbon group is, for example, preferably a hydrocarbon group having 1 or more and 20 or less carbon atoms, and more preferably a hydrocarbon group having 1 or more and 15 or less carbon atoms.

The aliphatic hydrocarbon group may be substituted with a substituent such as a halogen atom, a hydroxyl group, an amino group, and an aryl group.

Examples of the aromatic hydrocarbon group include a hydrocarbon group having 6 or more and 18 or less carbon atoms (for example, preferably 6 or more and 14 or less carbon atoms). Examples of the aromatic hydrocarbon group include a phenyl group, a naphthyl group, an anthracenyl group, and the like.

The aromatic hydrocarbon group may be substituted with a substituent such as a halogen atom, a hydroxyl group, an amino group, an alkyl group, and an alkoxy group.

The organic group represented by R may have a reactive group. Examples of the reactive group include a vinyl group, an allyl group, a styryl group, a maleimide group, an epoxy group, a (meth)acryloyl group, and the like.

A plurality of R's present in the structure A may be the same organic group or different organic groups.

However, among the plurality of R's present in the structure A, at least one R is a group including an alkyl group. Here, from the viewpoint of setting the FTW sliding angle within the above-described range, the group including an alkyl group is, for example, preferably the alkyl group itself or a siloxy group including an alkyl group. That is, at least one of the plurality of R's present in the structure A is, for example, preferably an alkyl group or a siloxy group containing an alkyl group.

The alkyl group is, for example, preferably an alkyl group having 1 or more to 9 or less carbon atoms and more preferably an alkyl group having 1 or more to 4 or less carbon atoms or an alkyl group having 1 carbon atom (that is, a methyl group). From the viewpoint of setting the FTW sliding angle within the above-described range, the number of carbon atoms in the alkyl group is, for example, preferably 1 or more and 4 or less.

In particular, from the viewpoint of setting the FTW sliding angle within the above-described range, the group including an alkyl group is, for example, preferably a trialkylsiloxy group.

From the viewpoint of setting the FTW sliding angle within the above-described range, the presence proportion of the group including an alkyl group in the siloxane compound SQ is, for example, preferably 10 mol % or more and 50 mol % or less and more preferably 25 mol % or more and 50 mol % or less with respect to the siloxane compound SQ.

The measuring method for the group including an alkyl group is as follows.

The present proportion is calculated from the peak height ratio corresponding to the group including an alkyl group and the compatible group in the infrared (IR) spectroscopy measurement and X-ray photoelectron spectroscopy (XPS) measurement.

The siloxane compound SQ is, for example, preferably a polymer compound called silsesquioxane, which has various skeletal structures.

The siloxane compound SQ may have, as a skeletal structure, any of a cage-type structure (a perfect cage-type structure or a cage-type structure), a ladder-type structure, or a random structure.

In the structure A, n in the formula represents an integer of 2 or more, and from the viewpoint of the oil repellency at a high temperature, for example, n preferably represents an integer of 8 or more and more preferably represents an integer of 8 or more and 10,000 or less.

From the viewpoint of setting the FTW sliding angle within the above-described range, the content of the siloxane compound SQ with respect to the surface layer is, for example, preferably 3% by volume or more, more preferably 6% by volume or more, and still more preferably 10% by volume or more.

The binding material includes a heat-resistant release material (a material for forming a surface layer).

Examples of the heat-resistant release material include a fluororubber, a fluororesin, a silicone resin, a silicone rubber, a polyimide resin, a polyether ether ketone (PEEK) resin, a polyphenylene sulfide (PPS) resin, a polymethylpentene (PMP) resin, and the like.

Among these, from the viewpoint of setting the FTW sliding angle within the above-described range, for example, a silicone resin or silicone rubber is preferable as the heat-resistant release material.

Examples of the silicone resin include a methyl-based straight silicone resin, a methylphenyl-based straight silicone resin, an acrylic resin-modified silicone resin, an ester resin-modified silicone resin, an epoxy resin-modified silicone resin, and an alkyd resin-modified silicone resin.

Examples of the silicone rubber include room temperature vulcanizing (RTV) silicone rubber, high temperature vulcanizing (HTV) silicone rubber, and liquid silicone rubber. Specific examples thereof include polydimethyl silicone rubber, methylvinyl silicone rubber, methylphenyl silicone rubber, and fluorosilicone rubber.

### Use of Fixing Member

The fixing member according to the present exemplary embodiment is applied to, for example, any of a heating belt and a pressure belt. The heating belt may be any of a heating belt that performs heating by an electromagnetic induction method or a heating belt that performs heating by an external heat source.

However, in a case where the fixing member according to the present exemplary embodiment is applied to a heating belt that heats the fixing member by an electromagnetic induction method, for example, a metal layer (heat generating layer) that generates heat by electromagnetic induction may be provided between the substrate and the elastic layer.

### Fixing Device

The fixing device according to the present exemplary embodiment has various configurations, for example, includes a first rotary member and a second rotary member arranged in contact with an outer surface of the first rotary member. Moreover, the fixing member according to the present exemplary embodiment is applied as least one of the first rotary member or the second rotary member.

Hereinafter, as first and second exemplary embodiments, a fixing device including a heating belt and a pressure roll will be described. Moreover, in the first and second exemplary embodiments, the fixing member according to the present exemplary embodiment may be used for both the heating belt and the pressure roll.

The fixing device according to the present exemplary embodiment is not limited to the first and second exemplary embodiments, and may be a fixing device including a heating roll or a heating belt and a pressure belt. Furthermore, the fixing member according to the present exemplary embodiment may be used for all the heating roll, the heating belt, and the pressure belt.

In addition, the fixing device according to the present exemplary embodiment is not limited to the first and second exemplary embodiments, and may be an electromagnetic induction heating type fixing device as in a third exemplary embodiment.

### FIRST EXEMPLARY EMBODIMENT OF FIXING DEVICE

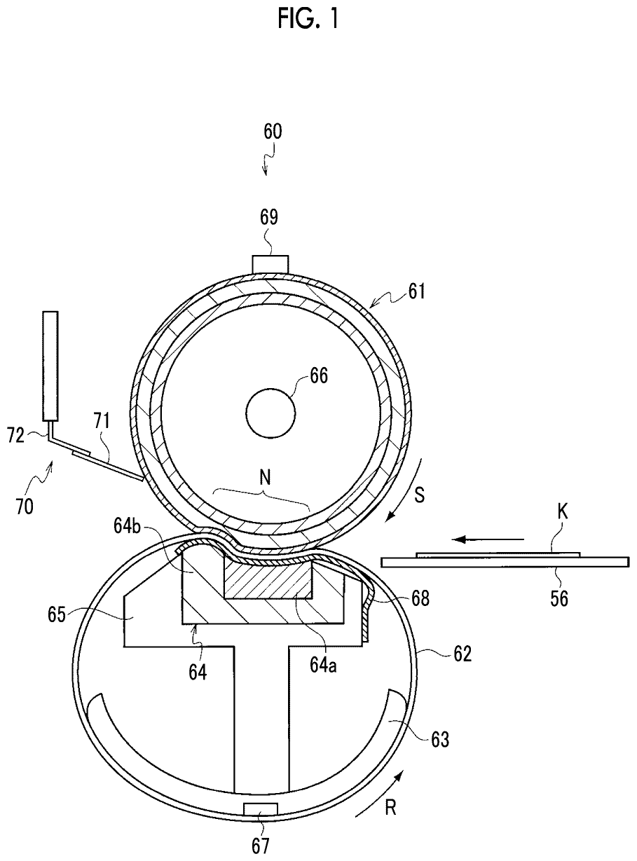

The fixing device according to the first exemplary embodiment will be described. FIG. 1 is a schematic view showing an example of the fixing device according to the first exemplary embodiment.

As shown in FIG. 1, a fixing device 60 according to the first exemplary embodiment is configured, for example, with a heating roll 61 (an example of the first rotary member) that is driven to rotate, a pressure belt 62 (an example of the second rotary member), and a pressing pad 64 (an example of a pressing member) that presses the heating roll 61 via the pressure belt 62.

Regarding the pressing pad 64, for example, the pressure belt 62 and the heating roll 61 may be relatively pressed. Therefore, the pressure belt 62 may be pressed on the heating roll 61, or the heating roll 61 may be pressed on the pressure belt 62.

A halogen lamp 66 (an example of heating means) is disposed on the inside of the heating roll 61. The heating means is not limited to the halogen lamp, and other heating members that generate heat may be used.

Meanwhile, for example, a thermosensitive element 69 is arranged in contact with a surface of the heating roll 61. The lighting of the halogen lamp 66 is controlled based on a temperature measurement value by the thermosensitive element 69, and the surface temperature of the heating roll 61 is kept at a target set temperature (for example, 150° C.).

The pressure belt 62 is rotatably supported by, for example, the pressing pad 64 arranged therein and a belt traveling guide 63. In a sandwiching region N (nip portion), the pressure belt is arranged to be pressed against the heating roll 61 by the pressing pad 64.

The pressing pad 64 is, for example, arranged in a state of being pressed against the heating roll 61 via the pressure belt 62 inside the pressure belt 62, and forms a sandwiching region N with the heating roll 61.

In the pressing pad 64, for example, a front sandwiching member 64a for securing a wide sandwiching region N is arranged on the inlet side of the sandwiching region N, and a peeling sandwiching member 64b for giving distortion to the heating roll 61 is arranged on the outlet side of the sandwiching region N.

In order to reduce sliding resistance between an inner peripheral surface of the pressure belt 62 and the pressing pad 64, for example, a sheet-like sliding member 68 is provided on a surface of the front sandwiching member 64a and the peeling sandwiching member 64b in contact with the pressure belt 62. The pressing pad 64 and the sliding member 68 are held by a metal holding member 65.

The sliding member 68 is provided, for example, so that a sliding surface thereof is in contact with the inner peripheral surface of the pressure belt 62, and is involved in holding and supplying an oil present between the sliding member 68 and the pressure belt 62.

For example, the belt traveling guide 63 is attached to the holding member 65, and the pressure belt 62 is configured to rotate.

The heating roll 61 rotates, for example, in the direction of the arrow S by a drive motor (not shown), and following the above rotation, the pressure belt 62 rotates in the direction of the arrow R opposite to the rotation direction of the heating roll 61. That is, for example, the heating roll 61 rotates clockwise in FIG. 1, while the pressure belt 62 rotates counterclockwise.

Then, paper K (an example of a recording medium) having an unfixed toner image is guided by, for example, a fixing inlet guide 56 and transported to the sandwiching region N. In a case where the paper K passes through the sandwiching region N, the toner image on the paper K is fixed by the pressure and heat acting on the sandwiching region N.

In the fixing device 60 according to the first exemplary embodiment, for example, by the front sandwiching member 64a in the form of a recess conforming to the outer peripheral surface of the heating roll 61, a wider nip region N is secured, compared to a configuration having no front sandwiching member 64a.

In addition, the fixing device 60 according to the first exemplary embodiment is configured, for example, with the peeling sandwiching member 64b that is arranged to protrude toward the outer peripheral surface of the heating roll 61, such that the heating roll 61 is locally distorted much in the outlet region of the sandwiching region N.

In a case where the peeling sandwiching member 64b is arranged as above, for example, the paper K after fixing passes through the distortion formed locally large when passing through the peeling sandwiching region, and thus the paper K is easy to be peeled off from the heating roll 61.

As auxiliary means for peeling, for example, a peeling member 70 is disposed on the downstream side of the sandwiching region N of the heating roll 61. The peeling member 70 is, for example, held by a holding member 72 in a state where a peeling claw 71 is close to the heating roll 61 in a direction facing the rotation direction of the heating roll 61 (counter direction).

### SECOND EXEMPLARY EMBODIMENT OF FIXING DEVICE

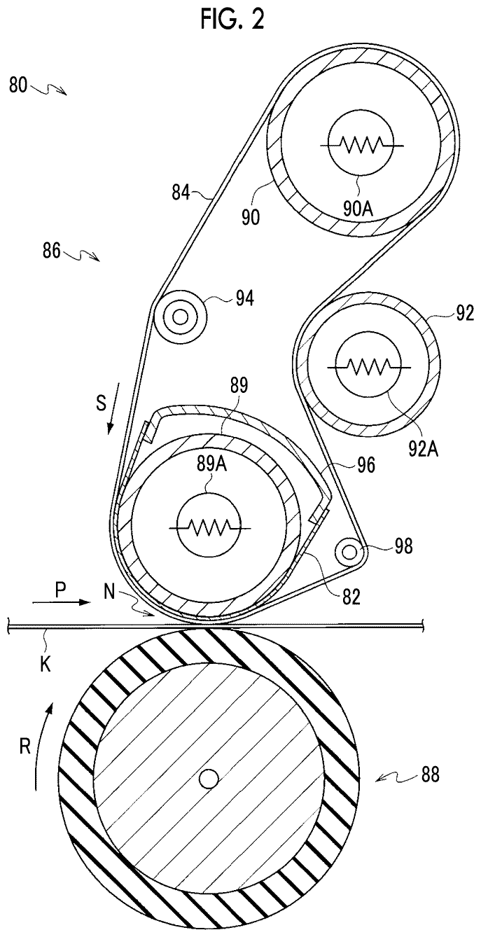

The fixing device according to the second exemplary embodiment will be described. FIG. 2 is a schematic view showing an example of the fixing device according to the second exemplary embodiment.

As shown in FIG. 2, a fixing device 80 according to the second exemplary embodiment is configured, for example, with a fixing belt module 86 including a heating belt 84 (an example of the first rotary member) and a pressure roll 88 (an example of the second rotary member) that is arranged in a state of being pressed on the heating belt 84 (fixing belt module 86). For example, the sandwiching region N (nip portion) where the heating belt 84 (fixing belt module 86) and the pressure roll 88 are in contact with each other is formed. In the sandwiching region N, the paper K (an example of the recording medium) is pressed and heated, and the toner image is fixed.

The fixing belt module 86 includes, for example, an endless heating belt 84, a heating and pressing roll 89 around which the heating belt 84 is wound on the side of the pressure roll 88, and which is rotationally driven by the rotational force of a motor (not shown) and presses the heating belt 84 from an inner peripheral surface thereof toward the pressure roll 88, and a support roll 90 which supports the heating belt 84 from the inside at a position different from the heating and pressing roll 89.

The fixing belt module 86 is provided with, for example, a support roll 92 which is arranged outside the heating belt 84 and defines a circulating path thereof, a posture correction roll 94 which corrects the posture of the heating belt 84 from the heating and pressing roll 89 to the support roll 90, and a support roll 98 which applies a tension to the heating belt 84 from the inner peripheral surface on the downstream side of the sandwiching region N which is a region where the heating belt 84 (fixing belt module 86) and the pressure roll 88 are in contact with each other.

The fixing belt module 86 is provided, for example, so that a sheet-like sliding member 82 is interposed between the heating belt 84 and the heating and pressing roll 89.

The sliding member 82 is provided, for example, so that a sliding surface thereof is in contact with an inner peripheral surface of the heating belt 84, and is involved in holding and supplying an oil present between the sliding member 82 and the heating belt 84.

Here, the sliding member 82 is provided, for example, in a state where both ends thereof are supported by a support member 96.

For example, a halogen heater 89A (an example of the heating means) is provided inside the heating and pressing roll 89.

The support roll 90 is, for example, a cylindrical roll made of aluminum, and a halogen heater 90A (an example of the heating means) is disposed therein, so that the heating belt 84 is heated from the inner peripheral surface side.

At both ends of the support roll 90, for example, spring members (not shown) pressing the heating belt 84 outward are disposed.

The support roll 92 is, for example, a cylindrical roll formed of aluminum, and a release layer formed of a fluororesin having a thickness of 20 μm is formed on a surface of the support roll 92.

The release layer of the support roll 92 is formed, for example, to prevent a toner or paper dust from the outer peripheral surface of the heating belt 84 from accumulating on the support roll 92.

For example, a halogen heater 92A (an example of a heating source) is disposed inside the support roll 92 so that the heating belt 84 is heated from the outer peripheral surface side.

That is, for example, the heating and pressing roll 89, the support roll 90, and the support roll 92 are configured to heat the heating belt 84.

The posture correction roll 94 is, for example, a columnar roll made of aluminum, and an end position measurement mechanism (not shown) for measuring the end position of the heating belt 84 is arranged in the vicinity of the posture correction roll 94.

In the posture correction roll 94, for example, an axial displacement mechanism (not shown) which displaces a contact position of the heating belt 84 in an axial direction according to the measurement result of the end position measurement mechanism is disposed, and the posture correction roll 94 is configured to control meandering of the heating belt 84.

Meanwhile, the pressure roll 88 is, for example, rotatably supported, and the heating belt 84 is provided to be being pressed against a portion wound around the heating and pressing roll 89 by urging means such as a spring (not shown). As a result, as the heating belt 84 (heating and pressing roll 89) of the fixing belt module 86 moves rotationally in the direction of the arrow S, the pressure roll 88 follows the heating belt 84 (heating and pressing roll 89) and moves rotationally in the direction of the arrow R.

Then, in a case where the paper K having an unfixed toner image (not shown) is transported in the direction of the arrow P and guided to the sandwiching region N of the fixing device 80, the image is fixed by the pressure and heat acting on the sandwiching region N.

For the fixing device 80 according to the second exemplary embodiment, an embodiment has been described in which a halogen heater (halogen lamp) is used as an example of a heating source. However, the fixing device is not limited thereto, and a radiation lamp heating element (a heating element generating radiation (such as infrared rays) and a resistance heating element (a heating element generating Joule heat by passing an electric current through a resistor: for example, a heating element obtained by forming a film with a resistor on a ceramic substrate and firing the resultant) other than the halogen heater may be used.

### THIRD EXEMPLARY EMBODIMENT OF FIXING DEVICE

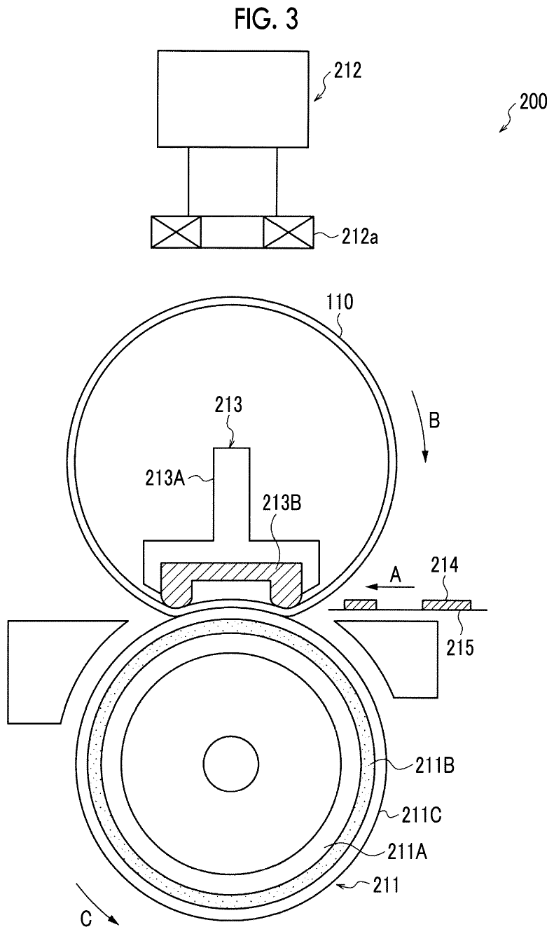

The fixing device according to the third exemplary embodiment will be described. FIG. 3 is a schematic view showing an example of the fixing device according to the third exemplary embodiment.

A fixing device 200 according to the third exemplary embodiment is an electromagnetic induction heating type fixing device including a fixing member 110 having a metal layer. In the fixing device 200 according to the third exemplary embodiment, the fixing member 110 is used as a belt.

As shown in FIG. 3, a pressure roll (pressure member) 211 is arranged to pressurize a part of the belt 110, a contact region (nip) is formed between the fixing member 110 and the pressure roll 211 from the viewpoint of efficiently performing fixing, and the belt 110 is bent in a shape along a peripheral surface of the pressure roll 211. In addition, from the viewpoint of ensuring the peelability of a recording medium, a bent portion where the belt is bent is formed at the end of the contact region (nip).

The pressure roll 211 is configured with an elastic layer 211B made of silicone rubber or the like that is formed on a substrate 211A, and a release layer 211C made of a fluorine-based compound that is formed on the elastic layer 211B.

On the inside of the belt 110, an opposing member 213 is arranged at a position facing the pressure roll 211. The opposing member 213 is formed of a metal, a heat-resistant resin, heat-resistant rubber, or the like, and has a pad 213B that is in contact with the inner peripheral surface of the belt 110 to locally increase the pressure, and a support 213A that supports the pad 213B.

An electromagnetic induction heating device 212 having a built-in electromagnetic induction coil (excitation coil) 212a is provided at a position facing the pressure roll 211 (an example of the pressure member) across the belt 110. The electromagnetic induction heating device 212 applies an AC current to the electromagnetic induction coil, such that the generated magnetic field changes by an excitation circuit and an eddy current is generated in a metal layer (not shown in the drawing, for example, an electromagnetic induction metal layer) of the belt 110. The eddy current is converted into heat (Joule heat) by the electric resistance of the metal layer not shown in the drawing. As a result, the surface of the belt 110 generates heat.

The position of the electromagnetic induction heating device 212 is not limited to the position shown in FIG. 3. For example, the electromagnetic induction heating device 212 may be installed on the upstream side in the rotation direction B with respect to the contact region of the belt 110, or may be installed on the inside of the belt 110.

In the fixing device 200 according to the third exemplary embodiment, by a driving device, a driving force is transmitted to the gear fixed to the end of the belt 110. As a result, the belt 110 performs self-rotation in the direction of the arrow B, and as the belt 110 rotates, the pressure roll 211 rotates in the opposite direction, that is, in the direction of the arrow C.

A recording medium 215 on which an unfixed toner image 214 is formed is passed through a contact region (nip) between the belt 110 and the pressure roll 211 in the fixing device 200 in the direction of the arrow A, and pressure is applied to the molten unfixed toner image 214. As a result, the unfixed toner image 214 is fixed onto the recording medium 215.

### Image Forming Apparatus

Next, the image forming apparatus according to the present exemplary embodiment will be described.

The image forming apparatus of the present exemplary embodiment includes an image holder, a charging unit that charges a surface of the image holder, a latent image forming unit that forms a latent image on the charged surface of the image holder, a developing unit that develops the latent image with a toner to form a toner image, a transfer unit that transfers the toner image to a recording medium, and a fixing unit that fixes the toner image onto the recording medium. As the fixing unit, the fixing device according to the present exemplary embodiment is used.

Hereinafter, an image forming apparatus according to the present exemplary embodiment will be described with reference to a drawing.

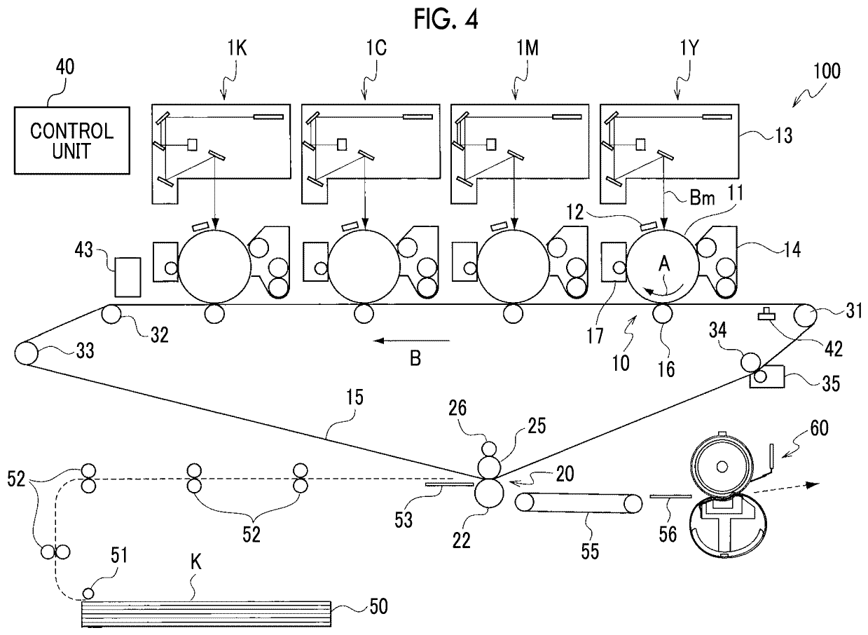

FIG. 4 is a schematic configuration view showing the configuration of the image forming apparatus according to the present exemplary embodiment.

As shown in FIG. 4, an image forming apparatus 100 according to the present exemplary embodiment is, for example, an intermediate transfer-type image forming apparatus that is generally called a tandem type, and includes a plurality of image forming units 1Y, 1M, 1C, and 1K in which a toner image of each color component is formed by an electrophotographic method, a primary transfer portion 10 that performs sequential transfer (primary transfer) of the toner image of each color component formed by each of the image forming units 1Y, 1M, 1C, and 1K to an intermediate transfer belt 15, a secondary transfer portion 20 that performs batch transfer (secondary transfer) of the overlapped toner images transferred to the intermediate transfer belt 15 to paper K as a recording medium, and a fixing device 60 that fixes the images transferred by the secondary transfer on the paper K. The image forming apparatus 100 also has a control unit 40 that controls the operation of each device (each portion).

The fixing device 60 is the fixing device 60 according to the first exemplary embodiment described above. The image forming apparatus 100 may be configured to include the fixing device 80 according to the second exemplary embodiment described above, or may be configured to the fixing device 200 according to the third exemplary embodiment described above.

Each of the image forming units 1Y, 1M, 1C, and 1K of the image forming apparatus 100 includes a photoreceptor 11 that rotates in the direction of an arrow A, as an example of an image holder that holds a toner image formed on the surface.

As an example of the charging unit, a charger 12 for charging the photoreceptor 11 is provided around the photoreceptor 11. As an example of the electrostatic charge image forming unit, a laser exposure machine 13 that draws an electrostatic charge image on the photoreceptor 11 is provided (in the figure, an exposure beam is represented by a mark Bm).

Around the photoreceptor 11, as an example of the developing unit, there are provided a developing machine 14 that accommodates toners of each color component and makes the electrostatic charge image on the photoreceptor 11 into a visible image by using the toners and a primary transfer roll 16 that transfers toner images of each color component formed on the photoreceptor 11 to the intermediate transfer belt 15 by the primary transfer portion 10.

Around the photoreceptor 11, there are provided a photoreceptor cleaner 17 that removes the residual toner on the photoreceptor 11 and devices for electrophotography, such as the charger 12, the laser exposure machine 13, the developing machine 14, the primary transfer roll 16, and the photoreceptor cleaner 17, that are disposed in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

The intermediate transfer belt 15 which is an intermediate transfer body is configured with a film-shaped pressure belt including a base layer that is a resin such as polyimide or polyamide and containing an appropriate amount of an antistatic agent such as carbon black. Then, the intermediate transfer belt 15 is configured to have a volume resistivity of 10⁶ Ωcm or more and 10¹⁴ Ωcm or less and has a thickness of about, for example, 0.1 mm.

By various rolls, the intermediate transfer belt 15 is driven to circulate (rotate) in a direction B shown in FIG. 4 at a speed fit for the purpose. The image forming apparatus 100 has, as the various rolls, a driving roll 31 that is driven by a motor (not shown in the drawing) excellent in maintaining a constant speed and rotates the intermediate transfer belt 15, a support roll 32 that supports the intermediate transfer belt 15 substantially linearly extending along the arrangement direction of the photoreceptors 11, a tension applying roll 33 that applies tension to the intermediate transfer belt 15 and functions as a correcting roll preventing meandering of the intermediate transfer belt 15, a back roll 25 that is provided in the secondary transfer portion 20, and a cleaning back roll 34 that is provided in a cleaning portion scrapping off the residual toner on the intermediate transfer belt 15.

The primary transfer portion 10 is configured with the primary transfer roll 16 that is arranged to face the photoreceptor 11 across the intermediate transfer belt 15. The primary transfer roll 16 is configured with a core and a sponge layer as an elastic layer fixed around the core. The core is a cylindrical rod constituted of a metal such as iron or SUS. The sponge layer is a sponge-like cylindrical roll which is formed of blended rubber of NBR, SBR, and EPDM mixed with a conducting agent such as carbon black and has a volume resistivity of 10^{7.5} Ωcm or more and 10^{8.5} Ωcm or less.

The primary transfer roll 16 is arranged to be pressed on the photoreceptor 11 across the intermediate transfer belt 15, and the polarity of voltage (primary transfer bias) that is opposite to the charging polarity (negative polarity, the same shall apply hereinafter) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer portion 20 is configured to include the back roll 25 and a secondary transfer roll 22 that is arranged on a toner image-holding surface side of the intermediate transfer belt 15.

The surface of the back roll 25 is configured with a tube of blended rubber of EPDM and NBR in which carbon is dispersed, and the inside of the back roll 25 is configured with EPDM rubber. Then, the back roll 25 is formed such that the surface resistivity thereof is 10⁷ Ω/□ or more and 10¹⁰ Ω/□ or less. The hardness of the back roll 25 is set to, for example, 70° (ASKER C: manufactured by KOBUNSHI KEIKI CO., LTD., the same shall apply hereinafter). The back roll 25 is arranged on the back surface side of the intermediate transfer belt 15 to configure a counter electrode of the secondary transfer roll 22. A power supply roll 26 made of a metal to which secondary transfer bias is stably applied is arranged to come into contact with the back roll 25.

The secondary transfer roll 22 is configured with a core and a sponge layer as an elastic layer fixed around the core. The core is a cylindrical rod constituted of a metal such as iron or SUS. The sponge layer is a sponge-like cylindrical roll which is formed of blended rubber of NBR, SBR, and EPDM mixed with a conducting agent such as carbon black and has a volume resistivity of 10^{7.5} Ωcm or more and 10^{8.5} Ωcm or less.

The secondary transfer roll 22 is arranged to be pressed on the back roll 25 across the intermediate transfer belt 15. The secondary transfer roll 22 is grounded such that the secondary transfer bias is formed between the secondary transfer roll 22 and the back roll 25, which induces secondary transfer of the toner image onto the paper K transported to the secondary transfer portion 20.

On the downstream side of the secondary transfer portion 20 of the intermediate transfer belt 15, an intermediate transfer belt cleaner 35 separable from the intermediate transfer belt 15 is provided which removes the residual toner or paper powder on the intermediate transfer belt 15 remaining after the secondary transfer and cleans the surface of the intermediate transfer belt 15.

The intermediate transfer belt 15, the primary transfer portion 10 (primary transfer roll 16), and the secondary transfer portion 20 (secondary transfer roll 22) correspond to an example of the transfer unit.

On the other hand, on the upstream side of the yellow image forming unit 1Y, a reference sensor (home position sensor) 42 is disposed which generates a reference signal to be a reference for taking the image forming timing in each of the image forming units 1Y, 1M, 1C, and 1K. On the downstream side of the black image forming unit 1K, an image density sensor 43 for adjusting image quality is disposed. The reference sensor 42 recognizes a mark provided on the back side of the intermediate transfer belt 15 and generates a reference signal. Each of the image forming units 1Y, 1M, 1C, and 1K is configured such that these units start to form images according to the instruction from the control unit 40 based on the recognition of the reference signal.

The image forming apparatus according to the present exemplary embodiment includes, as transport means for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer portion 20, a transport belt 55 that transports the paper K transported after going through secondary transfer by the secondary transfer roll 22 to the fixing device 60, and a fixing inlet guide 56 that guides the paper K to the fixing device 60.

Next, the basic image forming process of the image forming apparatus according to the present exemplary embodiment will be described.

In the image forming apparatus according to the present exemplary embodiment, image data output from an image reading device not shown in the drawing, a personal computer (PC) not shown in the drawing, or the like is subjected to image processing by an image processing device not shown in the drawing, and then the image forming units 1Y, 1M, 1C, and 1K perform the image forming operation.

In the image processing device, image processing, such as shading correction, misregistration correction, brightness/color space conversion, gamma correction, or various image editing works such as frame erasing or color editing and movement editing, is performed on the input image data. The image data that has undergone the image processing is converted into color material gradation data of 4 colors, Y, M, C, and K, and is output to the laser exposure machine 13.

In the laser exposure machine 13, according to the input color material gradation data, for example, the photoreceptor 11 of each of the image forming units 1Y, 1M, 1C, and 1K is irradiated with the exposure beam Bm emitted from a semiconductor laser. The surface of each of the photoreceptors 11 of the image forming units 1Y, 1M, 1C, and 1K is charged by the charger 12 and then scanned and exposed by the laser exposure machine 13. In this way, an electrostatic latent image is formed. By each of the image forming units 1Y, 1M, 1C, and 1K, the formed electrostatic latent image is developed as a toner image of each of the colors Y, M, C, and K.

In the primary transfer portion 10 where each photoreceptor 11 and the intermediate transfer belt 15 come into contact with each other, the toner images formed on the photoreceptors 11 of the image forming units 1Y, 1M, 1C, and 1K are transferred onto the intermediate transfer belt 15. More specifically, in the primary transfer portion 10, by the primary transfer roll 16, a voltage (primary transfer bias) with a polarity opposite to the charging polarity (negative polarity) of the toner is applied to the substrate of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer portion 20. In a case where the toner images are transported to the secondary transfer portion 20, in the transport means, the paper feeding roll 51 rotates in accordance with the timing at which the toner images are transported to the secondary transfer portion 20, and the paper K having the target size is fed from the paper storage portion 50. The paper K fed from the paper feeding roll 51 is transported by the transport roll 52, passes through the transport guide 53, and reaches the secondary transfer portion 20. Before reaching the secondary transfer portion 20, the paper K is temporarily stopped, and a positioning roll (not shown in the drawing) rotates according to the movement timing of the intermediate transfer belt 15 holding the toner images, so that the position of the paper K is aligned with the position of the toner images.

In the secondary transfer portion 20, via the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer portion 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. Then, the paper K on which a fixed image is formed is transported to an ejected paper-storing portion (not shown in the drawing) provided in an output portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the back roll 34 for cleaning and an intermediate transfer belt cleaner 35.

Hitherto, the exemplary embodiments of the present invention have been described, but the present invention is not limited to the above exemplary embodiments. It goes without saying that various modifications, changes, and improvements can be made as long as the requirements of the present invention are satisfied.

### EXAMPLES

Hereinafter, the present invention will be more specifically described with reference to examples. However, the present invention is not limited to the following examples. In the following description, all “parts” and “%” are in terms of mass unless otherwise specified.

### Example 1

An N-methyl-2-pyrrolidone (NMP) solution of a polyimide precursor (polyimide varnish “U VARNISH-S”, manufactured by UBE Industries, Ltd.) is applied by spiral coating to a mold having a diameter of φ30 mm, and heated stepwise to 380° C. to sinter the polyimide precursor. In the stepwise heating, the temperature is increased from 25° C. to 120° C., maintained at 120° C. for 1 hour, increased from 120° C. to 250° C., maintained at 250° C. for 1 hour, increased from 250° C. to 380° C., maintained at 380° C. for 1 hour, and then reduced from 380° C. to 25° C.

In this manner, a tubular polyimide substrate (hereinafter, PI substrate) formed from a single polyimide resin layer having an outer diameter of 30 mm, a film thickness of 60 μm, and a width of 400 mm is obtained.

The surface of the PI substrate is subjected to a roughening treatment using a liquid honing device (LH-8TTHIS manufactured by FUJI SEIKI Co., Ltd.) to have a surface roughness Ra of 0.5 μm or more and 1.0 μm or less. As the honing conditions, abrasive grains #320 are used, the jet pressure is set to 0.3 MPa, the jet distance is set to 100 mm, and the treatment time is set to 1.5 minutes. Then, the abrasive grains on the surface of the roughened PI substrate are washed away with ion exchange water, and the moisture on the surface of the PI substrate is removed with compressed air.

Next, the PI substrate is incorporated into a plating jig, and an electroless nickel plating layer (a metal underlayer) having a thickness of 0.5 μm is formed by an electroless plating treatment.

Next, after forming the electroless copper plating layer (metal underlayer), electrodes are set at both ends of the plating jig, and an electrolytic plating treatment is performed using a copper sulfate plating liquid to form an electrolytic copper plating layer (metal heat generating layer) having a thickness of 10 μm.

Next, electrodes are set at both ends of the plating jig, and an electrolytic nickel plating treatment is performed using an electrolytic plating liquid to form an electrolytic nickel plating layer (metal protective layer) having a thickness of 10 μm.

Next, a liquid obtained by mixing and stirring equal amounts of a DY39-111 (Dow Toray Co., Ltd.)-A and B agents is prepared, applied to the surface of the nickel metal protective layer by spiral coating using a spiral coating device, air-dried (30 minutes) in a room temperature environment, and fired (170° C. for 20 minutes) to form an adhesive layer having a film thickness of 0.2 μm.

Next, a low hardness type silicone rubber (SE6744; Dow Toray Co., Ltd.) is diluted to 15% by mass with butyl acetate to obtain a coating liquid for forming an elastic layer. The coating liquid for forming an elastic layer is applied to the surface (that is, the outer peripheral surface) of the adhesive layer using a spiral coating device to a thickness of 200 μm to form a coating film.

Next, the formed coating film is subjected to a self-leveling treatment (40° C.×20 minutes) and primary vulcanization (120° C.×20 minutes) to form an elastic layer.

Next, a mixed solution is prepared by mixing 100 parts of a silicone resin “DOWSIL RSN-0806 Resin (manufactured by Dow Toray Co., Ltd.)” with 12 parts of a siloxane compound SQ1 (Octakis(trimethylsiloxy)silsesquioxane: Sigma-Aldrich Co., LLC.) in which R represents a trimethylsiloxy group in the structure A of [RSiO_{1.5}]ₙ.

A coating film of the mixed solution is formed on the elastic layer by dip coating using the obtained mixed solution. Then, the coating film is fired at 200° C. for 1 hour to form a surface layer of 10 μm.

Through the above steps, a fixing belt is obtained.

### Example 2

A fixing belt is obtained in the same manner as in Example 1, except that the blending amount of the siloxane compound SQ1 is set to 6 parts.

### Example 3

A fixing belt is obtained in the same manner as in Example 1, except that the blending amount of the siloxane compound SQ1 is set to 20 parts.

### Example 4

A fixing belt is obtained in the same manner as in Example 1, except that the blending amount of the siloxane compound SQ1 is set to 28 parts.

### Example 5

A fixing belt is obtained in the same manner as in Example 1, except that a siloxane compound SQ2 (PSS-Octakis ((dimethylsilyloxy) substituted): Sigma-Aldrich Co., LLC) in which R represents a dimethylsiloxy group in the structure A of [RSiO_{1.5}]ₙ is used instead of the siloxane compound SQ1.

### Example 6

A composition obtained by mixing 15 parts of the siloxane compound SQ2 with 100 parts by mass of a polyether ether ketone (PEEK) resin is molded by extrusion molding to obtain a tube having a thickness of 20 μm. The obtained tube is coated on the elastic layer and fired at 200° C. for 1 hour to form a surface layer. A fixing belt is obtained in the same manner as in Example 1 except for this operation.

### Comparative Example 1

A fixing belt is obtained in the same manner as in Example 1, except that a PFA (a copolymer of tetrafluoroethylene and perfluoroalkoxyethylene) tube having a thickness of 30 μm, of which an inner surface is treated with an excimer laser, is coated on the elastic layer and the tube is fired at 200° C. for 2 hours to form a surface layer.

### Evaluation

### Characteristics

The following characteristics of the fixing belt of each example are measured according to the method described above.
FTW sliding angle on the surface of the surface layer (sliding angle at 150° C. with respect to Fischer-Tropsch wax having a melting point of 90° C. and a penetration of 3 ( 1/10 mm))

### Gloss Unevenness

The fixing belt of each example is mounted on a fixing device of an image forming apparatus (a fixing device of “Apeos C4570”, FUJIFILM Business Innovation Corp.) as a heating belt.

By this image forming apparatus, 100 sheets of 100% solid black images are formed on one surface of A3JD COAT 127 (127 g/m²).

Then, the formed black solid image is observed, and the image gloss unevenness is compared by visual and sensory evaluation. The evaluation standards are as follows.
A: Very good
B: Good
C: Normal
D: Poor

The abbreviations shown in Table 1 are as follows.
SQ1: siloxane compound in which R represents a trimethylsiloxy group in the structure A of [RSiO_{1.5}]ₙ (Octakis(trimethylsiloxy)silsesquioxane: Sigma-Aldrich Co., LLC)
SQ2: siloxane compound in which R represents a dimethylsiloxy group in the structure A of [RSiO_{1.5}]ⁿ (PSS-Octakis (dimethylsyloxy) substituted: Sigma-Aldrich Co., LLC)

TABLE 1

| | Surface layer | | | | Eval- |
|---|---|---|---|---|---|
| | | Siloxane compound | | FTW | uation |
| | | | Content | sliding | Gloss |
| | Binding | | (% by | angle | uneven- |
| | material | Kind | volume) | (degree) | ness |
| Example 1 | Silicone resin | SQ1 | 10 | 20 | B |
| Example 2 | Silicone resin | SQ1 | 5 | 25 | C |
| Example 3 | Silicone resin | SQ1 | 15 | 15 | A |
| Example 4 | Silicone resin | SQ1 | 20 | 7 | A |
| Example 5 | Silicone resin | SQ2 | 10 | 25 | C |
| Example 6 | PEEK resin | SQ2 | 15 | 25 | C |

| | | | |
|---|---|---|---|
| Comparative | PFA tube | 30 | D |
| Example 1 | | | |

From the above results, it is found that, in Examples, the gloss unevenness is suppressed as compared with Comparative Examples.

The present exemplary embodiment includes the following aspects.

(((1)))

A fixing member comprising:
a surface layer having a sliding angle of 25 degrees or less at 150° C. with respect to a Fischer-Tropsch wax having a melting point of 90° C. and a penetration of 3 ( 1/10 mm).
   (((2)))

The fixing member according to (((1))),
wherein the sliding angle is 15 degrees or less.
   (((3)))

The fixing member according to (((1))) or (((2))),
wherein the surface layer includes a siloxane compound having a structure A of Formula: [RSiO_{1.5}]ₙ (provided that in the formula, R represents an organic group, and n represents an integer of 2 or more), and
at least one R among a plurality of R's present in the structure A is a group including an alkyl group.
   (((4)))

The fixing member according to (((3))),
wherein the group including an alkyl group is a trialkylsiloxy group.
   (((5))

The fixing member according to (((3))) or (((4))),
wherein a content of the siloxane compound with respect to the surface layer is 10% by volume or more.
   (((6)))

The fixing member according to any one of (((3))) to (((5))),
wherein the surface layer contains a resin.
   (((7)))

The fixing member according to (((6)),
wherein the resin is a silicone resin.
   (((8)))

A fixing device comprising:
a first rotary member; and
a second rotary member that is arranged to be in contact with an outer surface of the first rotary member,
wherein at least one of the first rotary member or the second rotary member is the fixing member according to any one of (((1))) to (((7))).
   (((9)))

An image forming apparatus comprising:
an image holder;
a charging unit that charges a surface of the image holder;
a latent image forming unit that forms a latent image on the charged surface of the image holder;
a developing unit that develops the latent image with a toner to form a toner image;
a transfer unit that transfers the toner image to a recording medium; and
a fixing unit that fixes the toner image onto the recording medium, the fixing unit being the fixing device according to (((8))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing member comprising:
a surface layer having a sliding angle of 25 degrees or less at 150° C. with respect to a Fischer-Tropsch wax having a melting point of 90° C. and a penetration of 3 ( 1/10 mm).

2. The fixing member according to claim 1,
wherein the sliding angle is 15 degrees or less.

3. The fixing member according to claim 1,
wherein the surface layer includes a siloxane compound having a structure A of Formula: [RSiO_{1.5}]ₙ (provided that in the formula, R represents an organic group, and n represents an integer of 2 or more), and
at least one R among a plurality of R's present in the structure A is a group including an alkyl group.

4. The fixing member according to claim 3,
wherein the group including an alkyl group is a trialkylsiloxy group.

5. The fixing member according to claim 3,
wherein a content of the siloxane compound with respect to the surface layer is 10% by volume or more.

6. The fixing member according to claim 3,
wherein the surface layer contains a resin.

7. The fixing member according to claim 6,
wherein the resin is a silicone resin.

8. A fixing device comprising:
a first rotary member; and
a second rotary member that is arranged to be in contact with an outer surface of the first rotary member,
wherein at least one of the first rotary member or the second rotary member is the fixing member according to claim 1.

9. A fixing device comprising:
a first rotary member; and
a second rotary member that is arranged to be in contact with an outer surface of the first rotary member,
wherein at least one of the first rotary member or the second rotary member is the fixing member according to claim 2.

10. A fixing device comprising:
a first rotary member; and
a second rotary member that is arranged to be in contact with an outer surface of the first rotary member,
wherein at least one of the first rotary member or the second rotary member is the fixing member according to claim 3.

11. A fixing device comprising:
a first rotary member; and
a second rotary member that is arranged to be in contact with an outer surface of the first rotary member,
wherein at least one of the first rotary member or the second rotary member is the fixing member according to claim 4.

12. A fixing device comprising:
a first rotary member; and
a second rotary member that is arranged to be in contact with an outer surface of the first rotary member,
wherein at least one of the first rotary member or the second rotary member is the fixing member according to claim 5.

13. A fixing device comprising:
a first rotary member; and
a second rotary member that is arranged to be in contact with an outer surface of the first rotary member,
wherein at least one of the first rotary member or the second rotary member is the fixing member according to claim 6.

14. A fixing device comprising:
a first rotary member; and
a second rotary member that is arranged to be in contact with an outer surface of the first rotary member,
wherein at least one of the first rotary member or the second rotary member is the fixing member according to claim 7.

15. An image forming apparatus comprising:
an image holder;
a charging unit that charges a surface of the image holder;
a latent image forming unit that forms a latent image on the charged surface of the image holder;
a developing unit that develops the latent image with a toner to form a toner image;
a transfer unit that transfers the toner image to a recording medium; and
a fixing unit that fixes the toner image onto the recording medium, the fixing unit being the fixing device according to claim 8.

16. An image forming apparatus comprising:
an image holder;
a charging unit that charges a surface of the image holder;
a latent image forming unit that forms a latent image on the charged surface of the image holder;
a developing unit that develops the latent image with a toner to form a toner image;
a transfer unit that transfers the toner image to a recording medium; and
a fixing unit that fixes the toner image onto the recording medium, the fixing unit being the fixing device according to claim 9.

17. An image forming apparatus comprising:
an image holder;
a charging unit that charges a surface of the image holder;
a latent image forming unit that forms a latent image on the charged surface of the image holder;
a developing unit that develops the latent image with a toner to form a toner image;
a transfer unit that transfers the toner image to a recording medium; and
a fixing unit that fixes the toner image onto the recording medium, the fixing unit being the fixing device according to claim 10.

18. An image forming apparatus comprising:
an image holder;
a charging unit that charges a surface of the image holder;
a latent image forming unit that forms a latent image on the charged surface of the image holder;
a developing unit that develops the latent image with a toner to form a toner image;
a transfer unit that transfers the toner image to a recording medium; and
a fixing unit that fixes the toner image onto the recording medium, the fixing unit being the fixing device according to claim 11.

19. An image forming apparatus comprising:
an image holder;
a charging unit that charges a surface of the image holder;
a latent image forming unit that forms a latent image on the charged surface of the image holder;
a developing unit that develops the latent image with a toner to form a toner image;
a transfer unit that transfers the toner image to a recording medium; and
a fixing unit that fixes the toner image onto the recording medium, the fixing unit being the fixing device according to claim 12.

20. An image forming apparatus comprising:
an image holder;
a charging unit that charges a surface of the image holder;
a latent image forming unit that forms a latent image on the charged surface of the image holder;
a developing unit that develops the latent image with a toner to form a toner image;
a transfer unit that transfers the toner image to a recording medium; and
a fixing unit that fixes the toner image onto the recording medium, the fixing unit being the fixing device according to claim 13.
